(19) United States
(12) Patent Application Publication
(10) Pub. No.: US 2004/0163169 A1
(43) Pub. Date: Aug. 26, 2004

(54) Hand-held shower attachment

(76) Inventors: Fabian Kollmann, Stuttgart (DE); Tom Schoenherr, Stuttgart (DE); Andreas Haug, Stuttgart (DE)

Correspondence Address: STEPHAN P. GRIBOK, DUANE MORRIS LLP, ONE LIBERTY PLACE, PHILADELPHIA, PA, 19103, US

(21) Appl. No.: 10/735,440

(22) Filed: Dec. 12, 2003

(30) Foreign Application Priority Data
Dec. 13, 2002 (DE) 10260208

(51) Int. Cl. B05B 1/00

(52) U.S. Cl. 4/615

(57) ABSTRACT

A hand-held shower attachment having a handgrip arranged on one side of its showerhead, where the ratio of the length of the grip to the maximum lateral dimension of the showerhead is less than unity, which will allow configuring a water-conserving shower attachment having a good rinsing action, is disclosed.

The invention is based on a hand-held shower attachment to be used for normal showering. Shower attachments that attempt to accomplish their intended purpose without using too much water in order to conserve water when showering have been available for some time.

One means for conserving water are so-alled “jet” shower attachments, which are also termed “rotor” shower attachments.

These have a vortex chamber, within which a vortex is generated, near their exit nozzle. Water then exits their exit nozzle in the form of a conical jet. The apex angle of this conical jet, and the water distribution therein, are determined by the interaction of the vortex chamber and the shape of their exit nozzle.

Normal shower attachments, for example, shower attachments that provide several types of water jets, have a flow restrictor that, for example, either reduces the flow rates of all jets or provides just a single flow-restricting setting. The diameters of the showerheads of such shower attachments are relatively small, which necessitates providing for a broad spreading of the water jets exiting them.

If these water jets are spread over a large angle, large fractions of the exiting water will miss the bodies of users, particularly if shower attachments are hand-held.

Shower attachments that lead to water bypassing the bodies of users invariably waste water.

Shower attachments having an oscillator that generates an oscillatory lateral motion of their water jets have been proposed as replacements for rotor-type shower attachments.

The invention is based on the problem of designing a hand-held shower attachment such that it will both help conserve water and provide a good wetting and good rinsing of users' skins.

In order to solve that problem, the invention proposes a hand-held shower attachment having those features stated in claim 1. Elaborations on the invention are covered by the subclaims.

Studies have shown that shower attachments that provide relatively gentle streams of water allow conserving water, since they provide good wetting and rinsing actions. The divergence angles of water jets exiting them should be no larger than necessary in order to prevent bypassing losses from becoming excessively large.

However, contact areas on users' skins should also not be excessively small in order to provide for rapid rinsing of large areas. Hand-held shower attachments should also be easy to handle, i.e., should not be overly bulky. All of these considerations have been taken into account by the invention Shower attachments may provide a relatively large area from which jets of water exit without necessarily becoming overly bulky. Jets of water exiting them may be confined to a narrow angle.

If their hand grip is to be used for fastening them in place, shortening the length of their grip in relation to the area of the surface from which jets of water exit will then also provide that changing its angular orientation need not lead to the location from which they exit being grossly shifted when the grip is rotated about its axis.

According to the invention, it may be provided that the showerhead and its housing will, around their entire perimeter, extend only slightly beyond the surface from which jets of water exit. The dimensions of the showerhead will therefore be optimally utilized.

Under an elaboration on the invention, it may be provided that the longitudinal axis of its grip is approximately parallel to the surface from which jets of water exit.

The shower hose that conducts water from the water supply to the showerhead is usually attached to the end of the handgrip, which may also be the case for the hand-held shower attachment proposed by the invention. The fitting for attaching the shower hose that is arranged on the end of the grip may be designed such that a union nut attached to the end of the shower hose forms an extension of the grip such that the grip will be extended by the union nut, which will allow further shortening that part of the grip into which the shower head is inserted. In other words, the longitudinal dimension of the union nut may be added to that of the grip when determining the overall length of the grip.

According to the invention, it may be provided that the depth of the shower head, measured normal to the surface from which jets of water exit, is approximately one-fourth to one-half the diameter of the surface from which, jets of water exit. The shower attachment will then be rather flat, overall.

The surface from which jets of water exit may be either planar or slightly domed, where a slightly concave, domed surface will be preferable. The perimeter of the surface from which jets of water exit may have an oval shape, where the longitudinal axis of the grip may be parallel to either its major axis or its minor axis.

However, it will be particularly preferable if the perimeter of the surface from which jets of water exit has a circular shape.

Other features, details, and benefits of the invention are as stated in the claims and the abstract, whose wordings are herewith made part of the content of the description by way of reference thereto, the following description of a preferred embodiment, and the figures, where the figures depict:

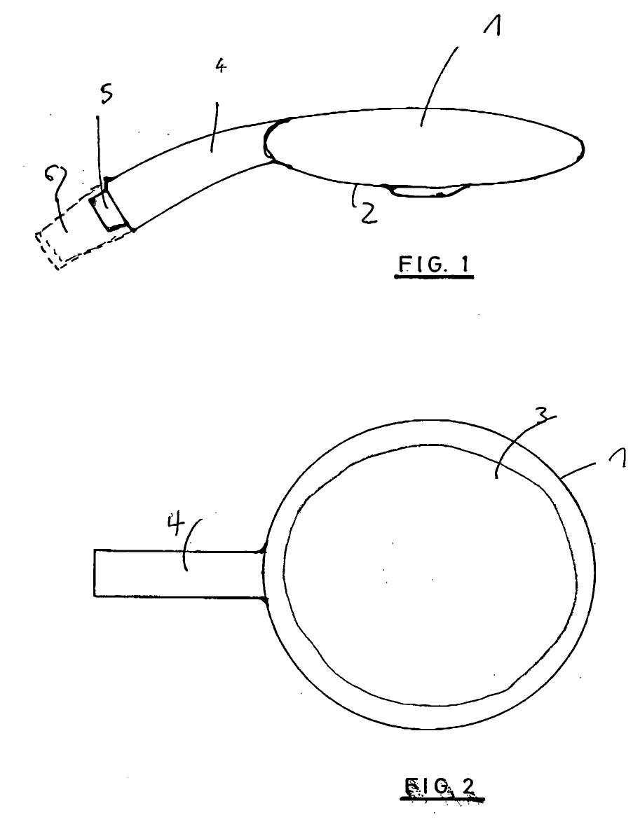

FIG. 1 a side view of a hand-held shower attachment proposed by the invention;

FIG. 2 a bottom view of the shower attachment shown in FIG. 1.

FIG. 1 depicts a schematized side view of a shower attachment proposed by the invention. The shower attachment has a showerhead 1, which, in the case of the example shown, is discus-shaped. A surface 3 from which jets of water exit (cf. FIG. 2) is formed on its bottom 2, when it is oriented as shown in FIG. 1. A handgrip 4 on the showerhead 1 is attached to one side of this surface 3 from which jets of water exit. In the event that the shower attachment is fabricated from plastic, this handgrip 4 may be injection-molded onto it, thereby forming a monolithic structure. In the case of the example shown, the handgrip 4 is slightly curved, thereby roughly continuing the shape of the showerhead 1. A threaded fitting 5 whose outer diameter is slightly less than that of the remainder of the grip 4 is formed on the end of the handgrip 4. A union nut 6, indicated by the dashed lines, that is attached to the end of shower hose (not shown) may thus be screwed onto the threaded fitting 5. The union nut 6 is designed such that its outer surface is flush with the outer surface of the handgrip 4.

The length of the handgrip 4 is much less than the maximum lateral dimension of the showerhead 1, measured transverse to an imaginary extension of the longitudinal axis of the handgrip 4.

FIG. 2 depicts a greatly simplified bottom view of the hand-held shower attachment shown in FIG. 1. From this bottom view, it may be seen that the perimeter of the shower head 1 has a circular shape and that the surface 3 from which jets of water exit, which extends outward nearly all the way to the perimeter of the shower head 1, also has a circular perimeter, thereby providing a very large area from which jets of water may exit in the form of a gentle stream. Due to the large area of the surface 3 from which jets of water exit, the apertures therein from which jets of water exit may be configured such that the divergence of the stream consisting of all such jets of water will be small in order that will only small quantities of water will bypass users' bodies during showering.

As may be seen from a comparison with FIG. 1, the ratio of the depth of the showerhead 1 to its maximum lateral dimension is approximately 0.25 to 0.5.

In the case of the known hand-held shower attachment, the ratio of the length of its handgrip to the maximum lateral dimension of its showerhead is approximately 1.8 to 2.5. The invention proposes that this ratio range from 0.5 to a maximum of unity, in which case, the area of the surface from which jets of water exit may be increased by as much as about 300% for a shower attachment having the same overall dimensions.

1. A hand-held shower attachment having a shower head that has a surface from which jets of water exit and a grip, the grip being attached to the shower head at a location alongside the surface from which jets of water exit, wherein the ratio of the length of the grip to the maximum lateral dimension of the surface on the shower head from which jets of water exit ranges from about 0.5 to unity.

2. A shower attachment according to claim 1, where the longitudinal axis of the grip is approximately parallel to the surface on the showerhead from which jets of water exit.

3. A shower attachment according to claim 1 having a fitting for a shower hose on the end of the grip opposite the showerhead.

4. A shower attachment according to claim 3, where a union nut on the end of a shower hose acts as part of the grip.

5. A shower attachment according to claim 1, where the ratio of the depth of the shower head, measured normal to the surface from which jets of water exit, to the diameter of the surface from which jets of water exit is approximately 0.25 to 0.5.

6. A shower attachment according to claim 1, where the perimeter of the surface from which jets of water exit has an approximately oval shape.

7. A shower attachment according to claim 1, where the perimeter of the surface from which jets of water exit has a circular shape.
